(19) United States
(12) Patent Application Publication
(10) Pub. No.: US 2025/0071503 A1
(43) Pub. Date: Feb. 27, 2025

(54) METHOD FOR RENDERING A SOUNDSCAPE OF A ROOM

(71) Applicant: SAINT-GOBAIN ECOPHON AB, HYLLINGE (SE)

(72) Inventors: Pierre Chigot, HELSINGBORG (SE); Erling Nilsson, LUND (SE)

(73) Assignee: SAINT-GOBAIN ECOPHON AB, HYLLINGE (SE)

(21) Appl. No.: 18/719,214

(22) PCT Filed: Jan. 10, 2023
(86) PCT No.: PCT/EP2023/050472

§ 371 Date: Jun. 12, 2024

(30) Foreign Application Priority Data
Jan. 13, 2022 (EP) 22151368.2

(51) Int. Cl. H04S 7/00

(52) U.S. Cl. CPC H04S 7/305

(57) ABSTRACT

The present disclosure relates to a method for rendering a soundscape of a room.

### TECHNICAL FIELD

The present invention relates to a method for rendering a soundscape of a room. The present invention further relates to a user device thereof.

### BACKGROUND OF THE INVENTION

Room acoustics are an important aspect of designing and decorating rooms. Depending on the activities performed in a room and/or a category of people in the room (e.g. people with hearing impairment), different acoustic characteristics are desired. For instance, in rooms which are intended to be used for presentations and/or giving lectures etc., such as a classroom or a conference/meeting room, it is desired to provide room acoustic properties which are ideally suited for facilitating the transmission of sound, particularly speech, to the intended audience. In other rooms, the aim can be to reduce sound levels as much as possible, such as in libraries, or in public places such as restaurants or cafés where a lot of people are gathered and talking at the same time. To achieve the desired room acoustics, one typically works with different materials of different surfaces (e.g. acoustical panels on walls and ceiling or carpet on the floor) and furnishings.

There is no such thing as a universally optimal room acoustics since every room is different. To find the right acoustical design can be a difficult process. Therefore, there is need for improved tools for aiding in the design of the room acoustics.

### SUMMARY OF THE INVENTION

In view of the above, it is an object of the present invention to provide a method for rendering a soundscape of a room.

The inventors of the present inventive concept have realized a contextualized and immersive way of simulating and visualizing a sound field of a room which allows for an improved way of designing acoustics of the room. The present inventive concept takes advantage of mixed reality, i.e. augmented reality (AR) or virtual reality (VR) to render a soundscape of the room in first person view of a user device, thereby allowing a user to be within the soundscape. This allows for a nuanced multi-level representation of the soundscape, allowing the immediate illustration of complex acoustic phenomena, such as flutter echoes, modes, angle dependent absorption, etc.

According to a first aspect, a method for rendering a soundscape of a room is provided. The method comprising: obtaining dimensions of the room; obtaining current position and orientation of a user device in the room; assigning one or more surfaces of the room with respective acoustical properties; calculating the soundscape in the room based on one or more sound sources, the acoustical properties of the one or more surfaces of the room and the dimensions of the room; and rendering the soundscape of the room by generating a virtual representation of the soundscape with respect to the current position and orientation of the user device and overlaying the virtual representation of the soundscape on a video stream of the room on a screen of the user device thereby forming a completely or partially rendered representation of the soundscape of the room.

The wording “rendering a soundscape” may be interpreted as reproducing the soundscape as a graphical representation (or virtual representation) visible for a user.

By the wording “soundscape” it is hereby meant a sound field within the room. The soundscape may represent a direction and intensity of sound waves or sound energy. The soundscape may further represent a frequency of the sound in the room.

Rendering the soundscape of the room according to the present inventive concept allows for an illustration of the way sound energy behaves in the room, depending on the nature of the room's surfaces and the geometry of the room.

The room should, unless stated otherwise, be interpreted as a real world indoor room. The surfaces of the room may for example comprise one or more walls, a floor, and/or a ceiling of the room. The surfaces may also comprise surfaces of furniture in the room. The surfaces may be boundary surfaces.

Assigning the surfaces with a respective acoustical property may be interpreted as pairing each surface with one or more predetermined material types, each material type being associated with at least one corresponding acoustical property.

The method may further comprise obtaining information pertaining to a furniture density within the room. Furniture density affects the acoustical properties of a room. It may therefore be advantageous to include this type of information since it allows for a more accurate calculation of the soundscape. The information may further pertain to other intrinsic acoustic properties of the room.

Calculating the soundscape in the room may comprise calculating one or more of sound pressure levels, reverberation time, speech clarity, strength, and sound propagation throughout the room. The soundscape may be calculated according to a predefined mesh of the room.

For example, the calculations can be based on information from a virtual ray tracing algorithm. Following the path of each emitted virtual ray the distance between successive hits of a building, structural surfaces and/or objects in the room is determined. Knowing the speed of sound and the absorption and/or scattering coefficients of the building, structural surfaces and any objects that might be hit by the ray, the energy loss at each encounter is calculated as a function of time. The result is a stepwise decaying curve representing the energy decay of each ray. In one example, an average of all the energy decay curves is calculated, yielding a total average energy decay curve. From the total average energy decay curve, room acoustic parameters such as reverberation time, speech clarity and sound strength are estimated assuming a linear decay and a diffuse sound field.

By the wording “virtual representation” it is hereby meant a graphical representation of the soundscape. The graphical representation of the soundscape may be in the form of particle patterns, intensity cues or the like.

Obtaining the position and orientation of the user device in the room allows the soundscape to be generated in first person view of the user device. The rendering of the soundscape may be continuously updated as the user device is moved and/or rotated in the room. In other words, the soundscape may be rendered in real time as the user moves within the room.

By the wording “overlaying” as in “overlaying the virtual representation of the soundscape on a video stream of the room” it is hereby meant displaying the soundscape on top of the video stream, i.e. such that the soundscape appears to be in the room. In other words, the soundscape is rendered in a mixed reality world, i.e. an augmented reality (AR) world, or in a virtual reality (VR) world.

The method according to the present inventive concept may be used for room acoustic planning from within the room. The method provides a real time, close to physico-realistic rendering of the soundscape. It allows to visualize, both in a steady state and a decay process, which surfaces of the room that appears to be impacted more than others. This information may then be used to conduct informed room acoustic design to make the most efficient use of a given quantity of sound absorption and/or other relevant acoustic properties, or a given amount of sound.

The method may further comprise placing a virtual object having known acoustical properties in the room, wherein calculating the soundscape may be further based on a position and orientation of the virtual object in the room and the acoustical properties of the virtual object.

In other words, the soundscape may be calculated as if the virtual object were to be placed as a real object in the room. This facilitates a real time adaptation of the soundscape in the room and an improved way of modifying the acoustical design of the room.

Placing the virtual object “in the room” should thus be interpreted as placing the virtual object in the room in the completely or partially rendered representation of the soundscape of the room.

Placing virtual objects in the room and then calculating the soundscape based on the virtual objects may be advantageous in that the effect of installing the virtual objects (e.g. sound absorption panels or sound scattering panels) can be determined without having to install the objects in the real world room.

The method may further comprise overlaying a virtual representation of the virtual object at its position and with its orientation on the video stream.

This allows a more intuitive way of placing and/or rearranging the virtual object in the room.

The act of obtaining dimensions of the room may comprise determining the dimensions of the room by scanning the room with the user device.

The one or more sound sources may be virtual sound sources. By the wording “virtual sound source” it is hereby meant that the sound source may be simulated. The soundscape may thus be calculated based on a virtual sound source.

The method may further comprise superposing the one or more virtual sound sources to one or more real sound sources. The soundscape may thus be calculated based on actual sound sources in the room.

The video stream of the room may be a real depiction of the room. Put differently, the video stream of the room may be captured by a camera of e.g. the user device. Overlaying the virtual representation of the soundscape on the video stream may thus result in an AR scene.

The video stream of the room may be a virtual depiction of the room. Put differently, the video stream may be a computer generated representation of the room. Overlaying the virtual representation of the soundscape on the video stream may thus result in a VR scene.

The act of assigning the one or more surfaces with respective acoustical properties may comprise: scanning, by the user device, the one or more surfaces, determining, from the scan, a material of each of the one or more surfaces, and assigning each of the one or more surfaces with acoustical properties associated with the respective determined material.

The acoustical properties may be one or more of absorption coefficient, diffusion pattern, angle dependent absorption and scattering coefficient.

According to a second aspect, a non-transitory computer-readable recording medium is provided. The non-transitory computer-readable recording medium having recorded thereon program code portion which, when executed at a device having processing capabilities, performs the method according to the first aspect.

The program may be downloadable to the device having processing capabilities from an application providing service.

The above-mentioned features of the first aspect, when applicable, apply to this second aspect as well. In order to avoid undue repetition, reference is made to the above.

According to a third aspect, a user device for rendering a soundscape of a room is provided. The user device comprises: circuitry configured to execute: a first obtaining function configured to obtain dimensions of the room; a second obtaining function configured to obtain current position and orientation of the user device in the room; an assigning function configured to assign one or more surfaces of the room with respective acoustical properties; a calculating function configured to calculate the soundscape in the room based on one or more sound sources, the acoustical properties of the one or more surfaces of the room and the dimensions of the room; and a rendering function configured to render the soundscape of the room by generating a virtual representation of the soundscape with respect to the current position and orientation of the user device and overlaying the virtual representation of the soundscape on a video stream of the room on a screen of the user device thereby forming completely or partially rendered representation of the soundscape of the room.

The circuitry may be further configured to execute a placing function configured to place a virtual object having known acoustical properties in the room; wherein the calculating function may be configured to calculate the soundscape further based on a position and orientation of the virtual object in the room and the acoustical properties of the virtual object.

The rendering function may be further configured to overlay a virtual representation of the virtual object at its position and with its orientation on the video stream.

The circuitry may be further configured to execute a determining function configured to determine the dimensions of the room by scanning the room with the user device.

The assigning function may be further configured to: scan, by the user device, the one or more surfaces, determine, from the scan, a material of each of the one or more surfaces, and assign each of the one or more surfaces with acoustical properties associated with the respective determined material.

The one or more sound sources may be virtual sound sources.

The circuitry may be further configured to execute a superposing function configured to superpose the one or more virtual sound sources to one or more real sound sources.

The video stream of the room may be a real depiction of the room.

The video stream of the room may be a virtual depiction of the room.

The above-mentioned features of the first and second aspects, when applicable, apply to this third aspect as well. In order to avoid undue repetition, reference is made to the above.

A further scope of applicability of the present disclosure will become apparent from the detailed description given below. However, it should be understood that the detailed description and specific examples, while indicating preferred variants of the present inventive concept, are given by way of illustration only, since various changes and modifications within the scope of the inventive concept will become apparent to those skilled in the art from this detailed description.

Hence, it is to be understood that this inventive concept is not limited to the particular steps of the methods described or component parts of the systems described as such method and system may vary. It is also to be understood that the terminology used herein is for purpose of describing particular embodiments only and is not intended to be limiting. It must be noted that, as used in the specification and the appended claim, the articles “a”, “an”, “the”, and “said” are intended to mean that there are one or more of the elements unless the context clearly dictates otherwise. Thus, for example, reference to “a device” or “the device” may include several devices, and the like. Furthermore, the words “comprising”, “including”, “containing” and similar wordings do not exclude other elements or steps.

### BRIEF DESCRIPTION OF THE DRAWINGS

The above and other aspects of the present inventive concept will now be described in more detail, with reference to appended drawings showing variants of the present inventive concept. The figures should not be considered limiting the invention to the specific variant; instead, they are used for explaining and understanding the inventive concept.

As illustrated in the figures, the sizes of layers and regions are exaggerated for illustrative purposes and, thus, are provided to illustrate the general structures of variants of the present inventive concept. Like reference numerals refer to like elements throughout.

FIG. 1 illustrates, by way of example, a user device for rendering a soundscape of a room.

FIG. 2 is a schematic representation of the user device.

FIG. 3 is a flow chart illustrating the steps of a method for rendering a soundscape of a room.

FIG. 4 is an illustration of partially a virtual and a real world seen through a user device.

FIG. 5 is an illustration of partially a virtual and a real world seen through a user device showing an example of a rendering of a sound scape.

FIG. 6 is an illustration of partially a virtual and a real world seen through a user device showing an example of a rendering of a sound scape with a first absorption of sound absorption at sound absorption panels.

FIG. 7 is an illustration of partially a virtual and a real world seen through a user device an example of a rendering of a sound scape with a second absorption of sound absorption at sound absorption panels.

### DETAILED DESCRIPTION

The present inventive concept will now be described more fully hereinafter with reference to the accompanying drawings, in which currently preferred variants of the inventive concept are shown. This inventive concept may, however, be implemented in many different forms and should not be construed as limited to the variants set forth herein; rather, these variants are provided for thoroughness and completeness, and fully convey the scope of the present inventive concept to the skilled person.

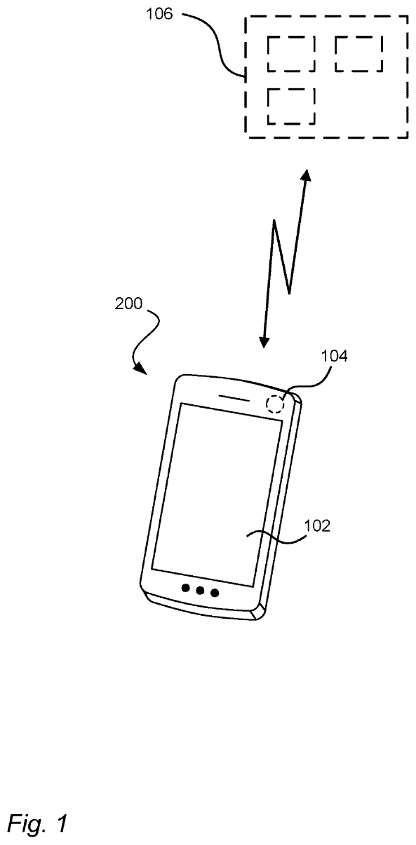

A method for rendering a soundscape of a room, as well as a user device thereof will now be described with reference to FIGS. 1 to 3.

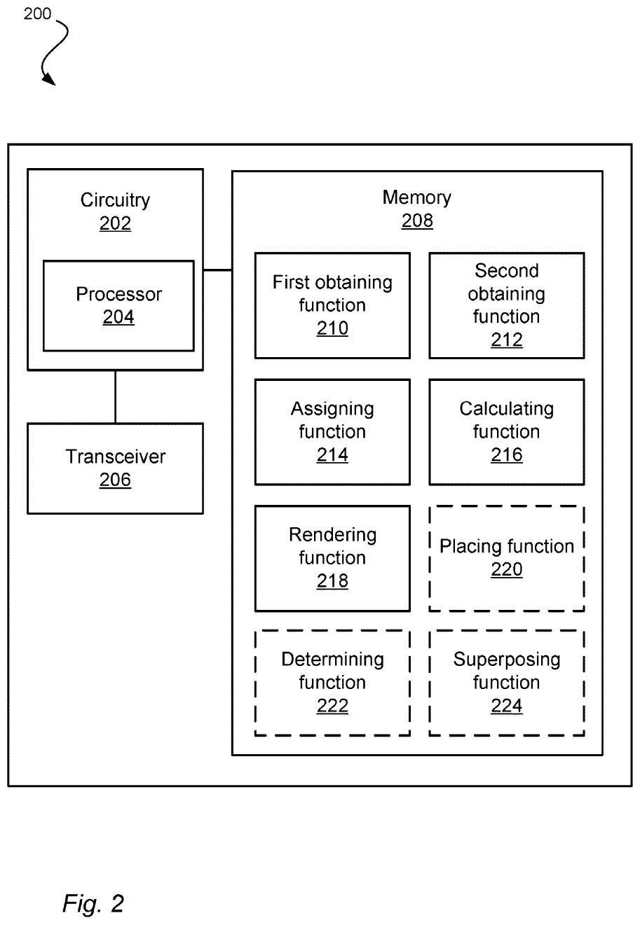

FIG. 1 illustrates, by way of example, the user device 200 for rendering a soundscape of a room. The functions of the user device 200 is further described in connection with FIG. 2. The user device 200 may be a portable electronic device, such as a smartphone (as illustrated herein), a tablet, a laptop, a smart watch, smart glasses, augmented reality (AR) glasses, AR lenses, virtual reality (VR) glasses, or any other suitable device. The user device 200 comprises a display 102. The user device 200 may further comprise a camera 104. The functions of the user device 200 may be distributed over multiple devices. As indicated in the illustrated example, a control unit 106 may be communicatively connected to the user device 200. The control unit 106 may be provided as a remote server, e.g. a cloud implemented server. The control unit 106 may perform some or all functions of the user device 200.

FIG. 2 is a schematic illustration of the user device 200 as described in connection with FIG. 1 above.

The user device 200 comprises circuitry 202. The circuitry 202 may physically comprise one single circuitry device. Alternatively, the circuitry 202 may be distributed over several circuitry devices. As shown in the example of FIG. 2, the user device 200 may further comprise a transceiver 206 and a memory 208. The circuitry 202 being communicatively connected to the transceiver 206 and the memory 208. The circuitry 202 may comprise a data bus (not illustrated in FIG. 2), and the circuitry 202 may communicate with the transceiver 206 and/or the memory 208 via the data bus.

The circuitry 202 may be configured to carry out overall control of functions and operations of the user device 200. The circuitry 202 may include a processor 204, such as a central processing unit (CPU), microcontroller, or microprocessor. The processor 204 may be configured to execute program code stored in the memory 208, in order to carry out functions and operations of the user device 200. The circuitry 202 is configured to execute a first obtaining function 210, a second obtaining function 212, an assigning function 214, a calculating function 216 and a rendering function 218. The circuitry 202 may further be configured to execute one or more of a placing function 220 and a determining function 222. The first obtaining function 210 and the second obtaining function 212 may be implemented as a single obtaining function. As mentioned above in connection with FIG. 1, one or more of the functions of the user device may be executed by an external control unit 106. For example, the calculating function and the rendering function may be executed by a remote server and the results transmitted to the user device 200 to be displayed on the display 102 of the user device 200.

The transceiver 206 may be configured to enable the user device 200 to communicate with other devices, e.g. the control unit as described above. The transceiver 206 may both transmit data from and receive data to the user device 200. For example, the user device 200 may collect data about dimensions of the room, or acoustical properties of surfaces of the room. This type of information may be collected from e.g. a remote server. Further, the user may input information to the user device. Even though not explicitly illustrated in FIG. 2, the user device 200 may comprise input devices such as one or more of a keyboard, a mouse, and a touchscreen. The user device 200 may further comprise sensors for collecting information about the surrounding room or its position and movement, such as the camera 104 as mentioned in connection with FIG. 1, a light detection and ranging sensor (LIDAR), a gyroscope and an accelerometer.

The memory 208 may be a non-transitory computer-readable storage medium. The memory 208 may be one or more of a buffer, a flash memory, a hard drive, a removable media, a volatile memory, a non-volatile memory, a random access memory (RAM), or another suitable device. In a typical arrangement, the memory 208 may include a non-volatile memory for long term data storage and a volatile memory that functions as system memory for the user device 200. The memory 208 may exchange data with the circuitry 202 over the data bus. Accompanying control lines and an address bus between the memory 208 and the circuitry 202 also may be present.

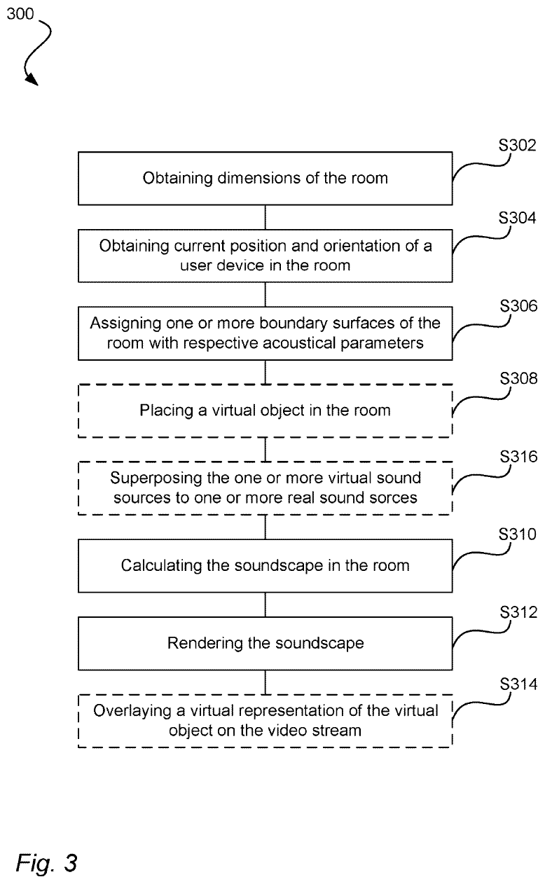

Functions and operations of the user device 200 may be implemented in the form of executable logic routines (e.g., lines of code, software programs, etc.) that are stored on a non-transitory computer readable recording medium (e.g., the memory 208) of the user device 200 and are executed by the circuitry 202 (e.g. using the processor 204). Put differently, when it is stated that the circuitry 202 is configured to execute a specific function, the processor 204 of the circuitry 202 may be configured execute program code portions stored on the memory 208, wherein the stored program code portions correspond to the specific function. Furthermore, the functions and operations of the circuitry 202 may be a stand-alone software application or form a part of a software application that carries out additional tasks related to the circuitry 202. The described functions and operations may be considered a method that the corresponding device is configured to carry out, such as the method discussed below in connection with FIG. 3. Also, while the described functions and operations may be implemented in software, such functionality may as well be carried out via dedicated hardware or firmware, or some combination of one or more of hardware, firmware, and software. The following functions may be stored on the non-transitory computer readable recording medium.

The first obtaining function 210 is configured to obtain dimensions of the room. The dimensions of the room may be a height, width, and depth of the room. The dimensions of the room may further comprise information pertaining to a height and width of each wall, floor, and surface of the room separately. The dimensions of the room may be the geometry of the room. The dimensions of the room may be obtained by receiving a user input from a user of the user device. Obtaining the dimensions of the room may comprise determining the room dimensions by scanning the room with the user device. The determining function 222 may be configured to determine the dimensions of the room by scanning the room with the user device. The functions of the determining function 222 may be performed by the first obtaining function 210. The scanning of the room may be performed by the camera of the user device. The scanning of the room may be performed semiautomatically, e.g. through so called selection of vertices where the user marks out intersection lines between the walls, floor, and ceiling in the scan of the room. The scanning of the room may be performed automatically, e.g. by using meshing functionalities based on room acquisition technologies such as the use of LIDAR.

The second obtaining function 212 is configured to obtain current position and orientation of the user device in the room. The current position and orientation of the user device in the room may be obtained from sensors in the user device, such as the accelerometer, gyroscope, camera, and LIDAR. The current position and orientation of the user device may be continuously updated as the user device is moved around in the room.

The assigning function 214 is configured to assign one or more surfaces of the room with respective acoustical properties. Assigning the one or more surfaces with respective acoustical properties may be performed by receiving a user input stating, for each surface, what material it is. The material for each surface may then be paired with corresponding acoustical properties.

The assigning function 214 may be further configured to scan, by the user device, the one or more surfaces, determine, from the scan, a material of each of the one or more surfaces, and assign each of the one or more surfaces with acoustical properties associated with the respective determined material. Determining, from the scan, the material of the one or more surfaces may be performed by use of image classification identifying the material.

The acoustical properties may be determined by use of intensity microphones. The intensity microphones may be directed towards a surface and measure how sound from a sound source with known properties interacts with the material of the surface.

The assigning function may further be configured to obtain information pertaining to furniture density in the room. The information pertaining to furniture density may be received by a user input stating a level of furniture density, e.g. low, medium or high furniture density. Alternatively, the furniture density may be obtained by use of image classification for identifying furniture in the room.

The acoustical properties may be one or more of absorption coefficient, angle dependent absorption and scattering coefficient. Other properties relating to the surface materials of the room, such as air flow resistivity, density, and thickness, that may form the basis for calculations of acoustical properties, may be obtained. These properties may be used in a subsequent step (further described below) in calculating the soundscape of the room. The absorption coefficient may relate to sound absorbing performance of a material. The absorption coefficient may further relate to the reflecting properties of the material. The angle dependent absorption may relate to how sound absorbing performance of a material is different depending on the angle of the incident sound. The scattering coefficient may relate to how the incident sound energy or sound wave is reflected, i.e. how it scatters.

The calculating function 216 is configured to calculate the soundscape in the room based on one or more sound sources and the acoustical properties of the one or more surfaces of the room. Calculating the soundscape may comprise simulating how the sound from the one or more sound sources interacts and propagates in the room. For instance, by calculating sound pressure levels throughout the room according to a predetermined mesh. The calculation of the soundscape may be performed by generating a virtual representation of the room in which the sound is simulated in. In other words, calculating the soundscape in the room may comprise simulating (and visualizing) how the sound energy/waves are absorbed or reflected, and in the latter case also scattered by the surface it is hitting. Calculating the soundscape may comprise calculating a reverberation time, speech clarity, sound strength and sound propagation in the room. Calculating the soundscape may be performed by any method generally used for simulating sound fields in rooms.

The one or more sound sources may have known positions and orientations within the room, so that the soundscape may be calculated further based on the positions and orientations of the one or more sound sources. The one or more sound sources may be virtual sound sources, i.e. artificial sound sources. The user may input a desired sound source with a specified sound profile and position in the room. The sound profile may specify pitch, power and directivity of the sound. The sound source may for instance simulate a mumbling sound representative of a busy café, a single speaker representative of a lecturer in a classroom or the ambient noise caused by a ventilation system in an office. Alternatively, or in combination, the one or more sound sources may be superpositions of one or more real sound sources. The circuitry may be further configured to execute a superposing function 224 configured to superpose the one or more virtual sound sources to one or more real sound sources. For example, the user device may record sound from real sound sources in the room and superpose the sound (with respect to e.g. its pitch, power and directivity) as one or more virtual sound sources. The virtual sound sources (either as inputted by the user or superposed from one or more real sound sources), may be rearranged in the room. The soundscape may then be recalculated to see how it alters the soundscape.

The rendering function 218 is configured to render the soundscape of the room by generating a virtual representation of the soundscape with respect to the current position and orientation of the user device and overlaying the virtual representation of the soundscape on a video stream of the room on a screen of the user device thereby forming a completely or partially rendered representation of the soundscape of the room. The user device may be moved around in the room such that its position and/or orientation is updated. The rendering of the soundscape may then be updated based on the updated position and/or orientation of the user device such that it depicts the same soundscape but from a different point of view. Put differently, a three dimensional representation of the soundscape is superposed with the physical environment in which it was calculated. In this way, the soundscape can be visualized in real time and in first person view of the user.

The completely or partially rendered representation of the soundscape of the room may be an augmented reality where the virtual representation of the soundscape constitutes the virtual part of the augmented reality and the video stream of the room constitutes the real part of the augmented reality. The video stream may be a virtual representation of the room. Thus, the completely or partially rendered representation of the soundscape of the room may be a completely virtual reality.

The placing function 220 may be configured to place a virtual object having known acoustical properties in the room. The calculating function may be configured to calculate the soundscape further based on a position and orientation of the virtual object in the room and the acoustical properties of the virtual object. The virtual object may further have known dimension and shape. The virtual object may be rearranged within the room, and the soundscape recalculated based on its new position and orientation. This allows the user to see how it alters the soundscape of the room.

The virtual object may be furniture, such as a couch, cushions, chairs, tables, rugs or the like. The virtual object may be acoustical design elements, such as sound absorbing free standing or furniture mounted screens, or sound absorbing, scattering or diffusing panels for walls or ceilings.

The virtual object may be placed according to a user defined input. The user input may further specify its acoustical properties and/or size and shape. Alternatively, the virtual object may be selected and/or placed automatically, to achieve a desirable acoustical design of the room. For example, the position, size, shape, material type and number of virtual objects may be determined such that is achieves the desirable acoustical design of the room. The desirable acoustical design of the room may for instance be to maximize a sound absorption in the room (e.g. in a café or library) or to enhance the acoustics for a speaker or performance (e.g. in a lecture hall or a theater). The selection and/or placement of the virtual object may be determined by use of a machine learning model.

It should be noted that multiple virtual objects, with the same or different acoustical properties, may be placed in the room. The calculation of the soundscape may then be based on the position and orientation of each virtual object of the multiple virtual objects.

The rendering function 218 may be further configured to overlay a virtual representation of the virtual object at its position and with its orientation on the video stream. Put differently, the virtual representation of the virtual object may be part of the virtual part of the augmented reality or virtual reality.

The virtual representation of the sound scape may be in the form of particle patterns, intensity cues or the like. The virtual representation may be a stationary representation of the soundscape, e.g. the sound pressure levels in the room. The virtual representation may be a dynamic representation of the soundscape, e.g. moving particles illustrating how the sound emitted from the one or more sound sources propagates in the room.

FIG. 3 is a flow chart illustrating the steps of the method 300 for rendering a soundscape of a room. The method may be a computer implemented method.

Below, the different steps are described in more detail. Even though illustrated in a specific order, the steps of the method 300 may be performed in any suitable order, in parallel, as well as multiple times.

Dimensions of the room is obtained S302. The dimensions of the room may be obtained passively, e.g. by receiving the dimensions from a user input. Alternatively, the dimensions of the room may be obtained actively. For example, the dimensions of the room may be determined by scanning the room with a user device.

Current position and orientation of the user device in the room is obtained S304.

One or more surfaces of the room are assigned S306 with respective acoustical properties.

The soundscape in the room is calculated S310 based on one or more sound sources, the acoustical properties of the one or more surfaces of the room and the dimensions of the room.

The soundscape of the room is rendered S312 by generating a virtual representation of the soundscape with respect to the current position and orientation of the user device and overlaying the virtual representation of the soundscape on a video stream of the room on a screen of the user device thereby forming a completely or partially rendered representation of the soundscape of the room.

Optionally, a virtual object having known acoustical properties may be placed S308 in the room. Calculating S310 the soundscape may be further based on a position and orientation of the virtual object in the room and the acoustical properties of the virtual object.

Optionally, a virtual representation of the virtual object may be overlayed S314 at its position and with its orientation on the video stream.

The one or more sound sources may be virtual sound sources.

The one or more virtual sound sources may be superposed (S316) to one or more real sound sources.

The video stream of the room may be a real depiction of the room.

The video stream of the room may be virtual depiction of the room.

Assigning the one or more surfaces with the respective acoustical properties may comprise scanning, by the user device, the one or more surfaces, determining, from the scan, a material of each of the one or more surfaces, and assigning each of the one or more surfaces with acoustical properties associated with the respective determined material.

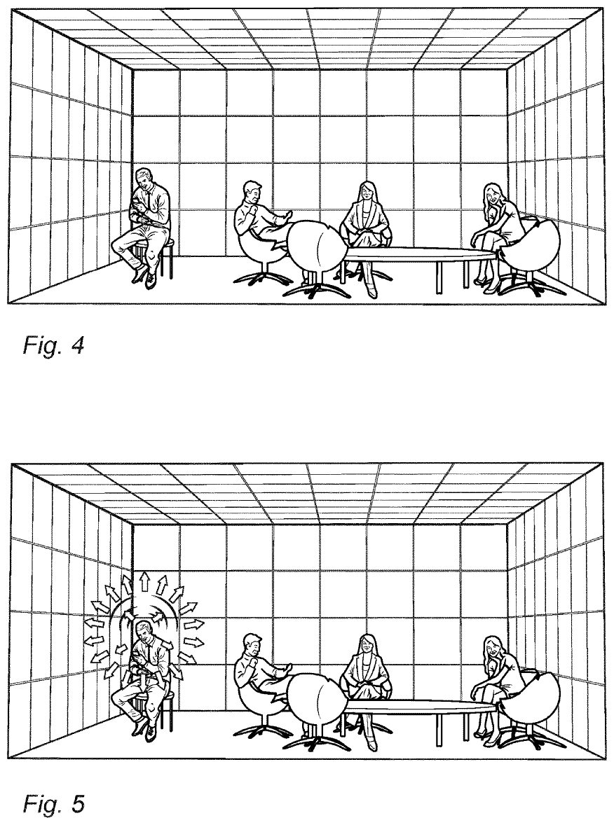

An example of the method 300 for rendering the soundscape of the room are illustrated in FIGS. 4-7.

FIG. 4 illustrates how a user views the room with the user device and through a combination of a real and virtual depiction of the room with participants sitting in the room as well as virtual objects placed on the walls and on the ceiling of the room, sound absorption panels. The dimensions of the room have in this example been obtained S302 by manually adding the room dimensions. Further, the current position and orientation of the user device in the room is obtained S304 by for example markers in the room, as well as one or more surfaces of the room have been manually assigned S306 with respective acoustical properties.

In FIG. 5 it can be further seen how the soundscape in the room is calculated S310 based on the voice of one of the participants talking, the acoustical properties of the one or more surfaces of the room, the dimensions of the room, a position and orientation of the sound absorption panels in the room and the acoustical properties of the sound absorption panels. The soundscape of the room is rendered S312 by generating a virtual representation of the soundscape with respect to the current position and orientation of the user device and overlaying the virtual representation of the soundscape on the video stream of the room on the screen of the user device thereby forming a partially rendered representation of the soundscape of the room. The soundscape of the room is for example illustrated by arrows that originate from the talking participant and the propagation of the sound, arrows, can be obtained by for example a ray tracing algorithm.

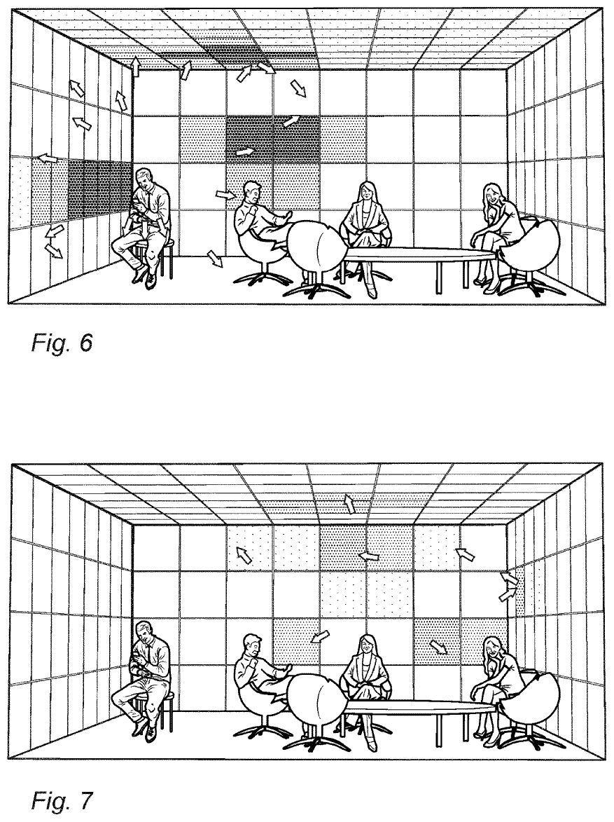

FIG. 6 further illustrates how the updated calculations and rendering of the soundscape S310, S312 as time moves on. It is further illustrated in FIG. 6 that the arrows, sound in this instance, are firstly reflected at a first set of different sound absorption panels on the wall and the ceiling. It can also be seen that the sound absorption panels are hit with a different amount of energy but also that they absorb or reflect different amounts of energy by the varying colors. FIG. 7 further illustrates how a second or further incidents of sound are reflected or absorbed by the sound absorption panels in the room. Altogether, this allows the user to see how the sound propagates in a room for an improved way of designing the acoustics of the room.

Additionally, variations to the disclosed variants can be understood and effected by the skilled person in practicing the claimed invention, from a study of the drawings, the disclosure, and the appended claims.

1. A method for rendering a soundscape of a room, the method comprising:
obtaining dimensions of the room;
obtaining current position and orientation of a user device in the room;
assigning one or more surfaces of the room with respective acoustical properties;
calculating the soundscape in the room based on one or more sound sources, the acoustical properties of the one or more surfaces of the room and the dimensions of the room; and
rendering the soundscape of the room by generating a virtual representation of the soundscape with respect to the current position and orientation of the user device and overlaying the virtual representation of the soundscape on a video stream of the room on a screen of the user device thereby forming a completely or partially rendered representation of the soundscape of the room.

2. The method according to claim 1, further comprising:
placing a virtual object having known acoustical properties in the room,
wherein calculating the soundscape is further based on a position and orientation of the virtual object in the room and the acoustical properties of the virtual object.

3. The method according to claim 2, further comprising overlaying a virtual representation of the virtual object at its position and with its orientation on the video stream.

4. The method according to claim 1, wherein obtaining dimensions of the room comprises determining the dimensions of the room by scanning the room with the user device.

5. The method according to claim 1, wherein the one or more sound sources are virtual sound sources.

6. The method according to claim 5, further comprising superposing the one or more virtual sound sources to one or more real sound sources.

7. The method according to claim 1, wherein the video stream of the room is a real depiction of the room.

8. The method according to claim 1, wherein the video stream of the room is a virtual depiction of the room.

9. The method according to claim 1, wherein assigning the one or more surfaces with respective acoustical properties comprises:
scanning, by the user device, the one or more surfaces,
determining, from the scan, a material of each of the one or more surfaces, and
assigning each of the one or more surfaces with acoustical properties associated with the respective determined material.

10. A non-transitory computer-readable recording medium having recorded thereon program code portion which, when executed at a device having processing capabilities, performs the method according to the claim 1.

11. A user device for rendering a soundscape of a room, the user device comprising:
circuitry configured to execute:
a first obtaining function configured to obtain dimensions of the room;
a second obtaining function configured to obtain current position and orientation of the user device in the room;
an assigning function configured to assign one or more surfaces of the room with respective acoustical properties;
a calculating function configured to calculate the soundscape in the room based on one or more sound sources, the acoustical properties of the one or more surfaces of the room and the dimensions of the room; and
a rendering function configured to render the soundscape of the room by generating a virtual representation of the soundscape with respect to the current position and orientation of the user device and overlaying the virtual representation of the soundscape on a video stream of the room on a screen of the user device thereby forming a completely or partially rendered representation of the soundscape of the room.

12. The user device according to claim 11, wherein the circuitry is further configured to execute a placing function configured to place a virtual object having known acoustical properties in the room;
wherein the calculating function is configured to calculate the soundscape further based on a position and orientation of the virtual object in the room and the acoustical properties of the virtual object.

13. The user device according to claim 12, wherein the rendering function is further configured to overlay a virtual representation of the virtual object at its position and with its orientation on the video stream.

14. The user device according to claim 11, wherein the circuitry is further configured to execute a determining function configured to determine the dimensions of the room by scanning the room with the user device.

15. The user device according to claim 11, wherein the assigning function is further configured to:
scan, by the user device, the one or more surfaces,
determine, from the scan, a material of each of the one or more surfaces, and
assign each of the one or more surfaces with acoustical properties associated with the respective determined material.
